(19) United States
(12) Patent Application Publication
(10) Pub. No.: US 2006/0292986 A1
(43) Pub. Date: Dec. 28, 2006

(54) Coexistent bluetooth and wireless local area networks in a multimode terminal and method thereof

(76) Inventors: Yigal Bitran, Tel-Aviv (IL); Lior Ophir, Herzlia (IL); Eyal Peleg, Kfar-Saba (IL); Itay Sherman, Raanan (IL); Matthew B. Shoemake, Allen, TX (US)

Correspondence Address: TEXAS INSTRUMENTS INCORPORATED, P O BOX 655474, M/S 3999, DALLAS, TX, 75265, US

(21) Appl. No.: 11/167,374

(22) Filed: Jun. 27, 2005

(51) Int. Cl. H04B 7/00; H04M 1/00

(52) U.S. Cl. 455/41.2; 455/562.1

(57) ABSTRACT

The present invention generally to a multimode terminal including a wireless local area network (WLAN) system and a Bluetooth system that avoids radio interference between the two systems by collaborative coexistence methods that include time-sharing, combined frequency and time-sharing, and forward looking combined frequency and time-sharing between the WLAN system and the Bluetooth system. The coexistent multimode terminal and the method of coexistence provide WLAN transmission/receptions that are not impacted when there is no Bluetooth traffic, Bluetooth transmissions/receptions that are not impacted when there is no WLAN traffic, Bluetooth and WLAN transmissions/receptions that are provided fair access to the medium when both Bluetooth and WLAN traffic are present, and high priority Bluetooth traffic, for example, voice traffic, that has priority over non-high WLAN traffic.

### CROSS-REFERENCES TO RELATED APPLICATIONS

None

### FIELD OF THE INVENTION

The present invention generally relates to a multimode terminal including a wireless local area network (WLAN) system and a Bluetooth system that avoids radio interference between the two systems by collaborative coexistence methods. More particularly, the present invention relates to collaborative coexistence methods that include time-sharing, combined frequency and time-sharing, and forward-looking combined frequency and time-sharing between a WLAN system and a Bluetooth system of a multimode terminal.

### BACKGROUND OF THE INVENTION

Coexistence is the mitigation or avoidance of radio interference between two radio communication technologies that use a common unlicensed radio frequency (RF) band. A multimode terminal, having both Bluetooth and wireless local area network (WLAN) radio transceivers, may be subject to radio interference from two sources. External interference comes from other Bluetooth and WLAN devices operating in the near vicinity of the victim transceiver. Internal interference is radiated from a transceiver, e.g., Bluetooth, in the same multimode terminal as the victim transceiver, e.g., WLAN.

Two approaches have been devised to promote coexistence between Bluetooth and WLAN devices that use the unlicensed 2.4 to 2.5 GHz Industrial, Scientific, and Medical (ISM) RF band: 1) collaborative techniques in which devices can share information and thus avoid one another's activity, and 2) non-collaborative techniques in which devices passively observe the other's behavior and modify their own to avoid it.

Bluetooth is a widely-recognized communication protocol for low cost, low power wireless devices that operate over a very small area, the so-called, personal area network. These wireless devices include, for example, telephone headsets, cell phones, Internet access devices, personal digital assistants, laptop computers, etc. Typically, the Bluetooth specification seeks to replace a connecting cable between communicating devices, for example, a cell phone and a headset, with a wireless radio link to provide greater ease of use by reducing the tangle of wires frequently associated with personal communication systems. Several such personal communication devices may be “wirelessly” linked together by using the Bluetooth specification, which derives its name from Harald Blatand (Blatand is Danish for Bluetooth), a 10th century Viking king who united Denmark and Norway.

To mitigate external RF interference, Bluetooth version 1.1 divides the 2.4 to 2.5 GHz RF band into 1 MHz-spaced channels. Each channel signals data packets at 1 Mb/s, using a Gaussian Frequency Shift Keying modulation scheme. A Bluetooth device transmits a modulated data packet to another Bluetooth device for reception. After a data packet is transmitted and received, both devices retune their radio to a different 1 MHz channel, effectively hopping from radio channel to radio channel, i.e., frequency-hopping spread spectrum (FHSS) modulation. In this way, Bluetooth devices use most of the available 2.4 to 2.5 GHz frequency band and if a particular signal packet transmission/reception is compromised by interference on one channel, a subsequent retransmission of the particular signal packet on a different channel is likely to be effective.

Bluetooth version 1.2 provides adaptive frequency hopping (AFH), a non-collaborative technique, in which a Bluetooth device is able to reduce the number of channels it hops across in response to an increase in packet error rates per channel. The frequency hopping Bluetooth device determines which channels are likely to be occupied by other devices and then modifies or adapts its frequency hopping pattern to avoid the occupied channels.

Bluetooth is a time division multiplexed system, where the basic unit of operation is a pair of time slots, each of the pair of time slots having a duration of 625 μs. A Master device transmits to a Slave device during a first time slot of 625 μs with both devices tuned to the same RF channel. During a second time slot, the Slave device must respond whether it successfully understood, or not, the last packet transmitted by the Master during the first time slot. As a Slave device must respond to a Master's transmission, communication between the two devices requires a pair of time slots of 1.25 ms duration. Following the pair of time slots, the two devices retune their radios, or hop, to the next channel in the frequency hopping sequence for a successive pair of time slots.

Data packets, when transmitted over networks, are frequently susceptible to delays by retransmission of packets caused by errors, sequence disorders caused by alternative transmission pathways, etc. Packet delays do not cause much of a problem with the transmission of digital data because the digital data may be retransmitted and re-sequenced by the receiver without effecting the operation of the receiving computer using the digital data. However, packet delays or dropped packets that carry voice signals, which are real-time sensitive, can cause unacceptable quality of service.

Bluetooth version 1.1 provides a Synchronous Connection Oriented (SCO) link for voice packets that is a symmetric link between Master and Slave devices with periodic exchange of voice packets during reserved time slots. The Master device will transmit SCO packets to the Slave device at regular intervals, defined as the SCO interval, which is counted in time slots. Bandwidth limitations limit Bluetooth version 1.1 to a maximum of three SCO links.

Bluetooth version 1.2 provides extended SCO (eSCO) channels that are error checking voice channels, which allow retransmission of corrupted voice data. As data rates can be negotiated via eSCO, the overall quality-of-service is improved. eSCO channels detect and re-transmit lost or corrupted voice packets to minimize impact on real-time performance.

The Institute of Electronic and Electrical Engineer's (IEEE's) 802.11 specification for wireless local area networks (WLANs) defines methods of RF modulation, e.g., direct sequence spread spectrum (DSSS), high-rate direct sequence spread spectrum (HR/DSSS), and orthogonal frequency division multiplexing (OFDM), that also use the same unlicensed 2.4 to 2.5 GHz RF band as Bluetooth devices.

Effective communication in a WLAN between stations and access points requires management of several functions. These management functions, e.g., broadcasting, polling, power-saving, joining, authenticating, associating, etc., are implemented by the transmission and reception of management frames between stations and access points of a WLAN. The content of these management frames is defined by the Media Access Control (MAC) sublayer of the 802.11 WLAN specification.

As Bluetooth personal area networks and WLANs use the same RF band of 2.4 GHz to 2.5 GHz, both external radio interference between the different devices and internal radio interference between the different transceivers of a multimode terminal using both Bluetooth and WLAN communication technologies can degrade network communications, e.g., by decreasing data throughput or by decreasing the quality of voice service. Therefore, there remains a need for a system and method that will provide coexistence, i.e., the absence or mitigation of external and internal radio interference, between Bluetooth and WLAN transceivers operating in a multimode terminal.

### SUMMARY OF THE INVENTION

Various exemplary embodiments of the present invention may provide a coexistent multimode terminal and a method of coexistence, in which wireless local area network (WLAN) transmissions/receptions are not impacted when there is no Bluetooth traffic, in which Bluetooth transmissions/receptions are not impacted when there is no WLAN traffic, in which Bluetooth and WLAN traffic, when both are present, are provided fair access to the medium, and in which high priority Bluetooth traffic, for example, voice traffic, has priority over non-high priority WLAN traffic. Additionally, in various exemplary embodiments of the present invention spurious transmissions may be avoided during either Bluetooth or WLAN transmissions/receptions.

An aspect of an exemplary embodiment of the present invention provides a coexistent multimode terminal comprising a wireless local area network system including a coexistence master, a Bluetooth system, a Bluetooth radio shut-down signal output from the coexistence master to the Bluetooth system, a first timing signal output from the Bluetooth system to the coexistence master, the first timing signal indicating transmission/reception by the Bluetooth system, and a first algorithm residing in the coexistence master, such that when WLAN data is available for transmission or the WLAN system recognizes an address match, the first algorithm causes the coexistence master to output the Bluetooth radio shut-down signal after the first timing signal from the Bluetooth system is deasserted.

Another aspect of an exemplary embodiment of the present invention provides a method of coexistence for a multimode terminal comprising determining by a coexistent WLAN system, whether WLAN data is to be transmitted or the coexistent WLAN system recognizes an address match, determining whether a Bluetooth system is transmitting/receiving by accessing a first timing signal from the Bluetooth system to the coexistent WLAN system, if the Bluetooth system is transmitting/receiving, then allowing a Bluetooth transmission/reception to complete, before disabling Bluetooth transmission by asserting a Bluetooth radio shut-down signal from the coexistent WLAN system, and if the Bluetooth system is not transmitting/receiving, then disabling the Bluetooth transmission.

Yet another aspect of an exemplary embodiment of the present invention provides a coexistent multimode terminal comprising a WLAN system including a coexistence master, a Bluetooth system, a Bluetooth radio shut-down signal output from the coexistence master to the Bluetooth system, data, including an interference frequency band, that is output from the WLAN system to the Bluetooth system, a first timing signal output from the Bluetooth system to the coexistence master, the first timing signal indicating transmission/reception by the Bluetooth system, wherein the first timing signal is output only when a frequency of transmission for the Bluetooth system falls within the interference frequency band, and a first algorithm residing in the coexistence master, such that when WLAN data is available for transmission or the WLAN system recognizes an address match, the first algorithm causes the coexistence master to output the Bluetooth radio shut-down signal after the first timing signal from the Bluetooth system is deasserted.

Yet another aspect of an exemplary embodiment of the present invention provides a method of coexistence for a multimode terminal comprising outputting from a coexistent WLAN system to a Bluetooth system, data including an interference frequency band, determining by the coexistent WLAN system, whether WLAN data is to be transmitted or the coexistent WLAN system recognizes an address match, determining whether a Bluetooth system is transmitting/receiving in the interference frequency band by accessing a first timing signal from the Bluetooth system to the coexistent WLAN system, wherein the first timing signal is output from the Bluetooth system only when a frequency of transmission of the Bluetooth system falls within the interference frequency band, if the Bluetooth system is transmitting/receiving in the interference frequency band, then allowing a Bluetooth transmission/reception to complete, before disabling Bluetooth transmission by asserting a Bluetooth radio shut-down signal from the coexistent WLAN system, and if the Bluetooth system is not transmitting/receiving in the interference frequency band, then disabling the Bluetooth transmission.

Yet another aspect of an exemplary embodiment of the present invention provides a coexistent multimode terminal comprising a WLAN system, a Bluetooth system, wherein the WLAN system includes a coexistence master that includes information of a transmission/reception frequency of the WLAN system and a duplicate of the Bluetooth system's frequency hopping scheduler, a Bluetooth radio shut-down signal output from the coexistence master to the Bluetooth system, a first timing signal output from the Bluetooth system to the coexistence master, the first timing signal indicating transmission/reception by the Bluetooth system, wherein the first timing signal is output only when a frequency of transmission for the Bluetooth system interferes with the transmission/reception frequency of the WLAN system, a clock signal and a reset signal output from the Bluetooth system to the coexistence master for synchronizing the coexistence master's duplicate of the Bluetooth system's frequency hopping scheduler with the Bluetooth frequency hopping scheduler, voice link parameter information that is transmitted ahead of time to the coexistence master, and a first algorithm residing in the coexistence master, such that when WLAN data is available for transmission or the WLAN system recognizes an address match, the first algorithm causes the coexistence master to output the Bluetooth radio shut-down signal after the first timing signal from the Bluetooth system is deasserted.

Yet another aspect of an exemplary embodiment of the present invention provides a method of coexistence for a multimode terminal comprising synchronizing a duplicate of a Bluetooth system's frequency hopping scheduler, residing in a coexistence master of a WLAN system, with the Bluetooth system's frequency hopping scheduler by clock and reset signal from the Bluetooth system, communicating, ahead of time, Bluetooth voice link parameter information to the coexistence master, determining by the coexistent WLAN system, whether WLAN data is to be transmitted or the WLAN system recognizes an address match, determining by the coexistent WLAN system, whether the Bluetooth system is transmitting/receiving in a frequency band, which overlaps a transmission frequency band of the coexistent WLAN system, by accessing a first timing signal from the Bluetooth system to the coexistent WLAN system, wherein the first timing signal is output from the Bluetooth system only when the frequency band of transmission/reception of the Bluetooth system overlaps the transmission frequency band of the coexistent WLAN system, if the Bluetooth system is transmitting/receiving in the transmission frequency band of the coexistent WLAN system, then allowing a Bluetooth transmission/reception to complete, before disabling Bluetooth transmission by asserting a Bluetooth radio shut-down signal from the coexistent WLAN system, and if the Bluetooth system is not transmitting/receiving in the transmission frequency band of the coexistent WLAN system, then disabling the Bluetooth transmission.

Yet another aspect of an exemplary embodiment of the present invention provides a coexistent multimode terminal comprising a WLAN system, a Bluetooth system, a Bluetooth radio shut-down signal output from the Bluetooth system, a first timing signal output from the Bluetooth system to the WLAN system, the first timing signal indicating transmission/reception by the Bluetooth system, wherein the first timing signal is output only when a frequency of transmission for the Bluetooth system interferes with the transmission/reception frequency of the WLAN system, a clock signal and a reset signal output from the Bluetooth system to the WLAN system for synchronizing the WLAN system to Bluetooth slot boundaries, data link parameter information, including a future hop sequence, that is transmitted ahead of time from the Bluetooth system to the WLAN system, and a first algorithm residing in the WLAN system, such that when WLAN data is available for transmission or the WLAN system recognizes an address match, the first algorithm causes the WLAN system to output the Bluetooth radio shut-down signal after the first timing signal from the Bluetooth system is deasserted.

Yet another aspect of an exemplary embodiment of the present invention provides a method of coexistence for a multimode terminal comprising synchronizing a WLAN system to slot boundaries of a Bluetooth system by clock and reset signals from the Bluetooth system, communicating, ahead of time, data voice link parameter information, including a future hop sequence, from the Bluetooth system to the WLAN system, determining by the WLAN system, whether WLAN data is to be transmitted or the WLAN system recognizes an address match, determining by the WLAN system, whether the Bluetooth system is transmitting/receiving in a frequency band, which overlaps a transmission frequency band of the WLAN system, by accessing a first timing signal from the Bluetooth system to the WLAN system, wherein the first timing signal is output from the Bluetooth system only when the frequency band of transmission/reception of the Bluetooth system overlaps the transmission frequency band of the WLAN system, if the Bluetooth system is transmitting/receiving in the transmission frequency band of the WLAN system, then allowing a Bluetooth transmission/reception to complete, before disabling Bluetooth transmission by asserting a Bluetooth radio shut-down signal from the WLAN system, and if the Bluetooth system is not transmitting/receiving in the transmission frequency band of the WLAN system, then disabling the Bluetooth transmission.

Yet another aspect of an exemplary embodiment of the present invention provides a coexistent multimode terminal further comprising a single antenna connected to a splitter/switch connected to a WLAN system's transceiver and a Bluetooth system's transceiver, wherein the WLAN system's transceiver and the Bluetooth system's transceiver are electrically isolated from one another by the splitter/switch by more than 15 dB.

Yet another aspect of an exemplary embodiment of the present invention provides a coexistent multimode terminal further comprising a single antenna including a first portion that transmits/receives a vertically polarized component of a radio signal and a second portion that transmits/receives a horizontally polarized component of the radio signal, wherein a WLAN system's transceiver is connected to the second portion and a Bluetooth system's transceiver is connected to the first portion of the single antenna, and the WLAN system's transceiver and the Bluetooth system's transceiver are electrically isolated from one another by the first portion and the second portion of the single antenna by more than 15 dB.

### BRIEF DESCRIPTION OF THE DRAWINGS

Exemplary embodiments of the present invention are discussed hereinafter in reference to the drawings, in which:

FIG. 1 illustrates a block diagram of a coexistent multimode terminal that may comprise a wireless local area network (WLAN) system and a Bluetooth system, which may communicate the times of Bluetooth activity to a coexistence master residing in the WLAN system via two or optionally three input/output lines in an exemplary embodiment of the present invention; and

FIG. 2 illustrates a timing diagram for a Bluetooth system that may communicate timing signals to a coexistence master for data packets, which are not designated high priority data, in an exemplary embodiment of the present invention; and

FIG. 3 illustrates a timing diagram for a Bluetooth system that may provide a high priority timing signal, PRI_DATA, which indicates activity of a Synchronous Connection Oriented (SCO) voice channel, to a coexistence master in an exemplary embodiment of the present invention; and

FIG. 4 illustrates a flow chart for the coexistent multimode terminal of FIG. 1, in which a coexistence master of the WLAN system may shutdown the radio frequency (RF) transceiver of the Bluetooth system, in an exemplary embodiment of the present invention; and

FIG. 5 illustrates a flow chart for a coexistent multimode terminal that may be appended to the flow chart of FIG. 4, when the WLAN coexistence master detects a high priority Bluetooth data communication, PRI_DATA, in an exemplary embodiment of the present invention; and

FIG. 6 illustrates a block diagram of a coexistent multimode terminal that may comprise a WLAN system and a Bluetooth system, which may communicate the combined times and frequencies of Bluetooth activity to a coexistence master residing in the WLAN system and which may communicate an interference frequency band to the Bluetooth system in an exemplary embodiment of the present invention; and

FIG. 7 illustrates a flowchart for the coexistent multimode terminal according to FIG. 6, in which the coexistence master of the WLAN determines whether a Bluetooth transmsission/reception falls within the interference frequency band of the WLAN system in an exemplary embodiment of the present invention; and

FIG. 8 illustrates a block diagram of a coexistent multimode terminal that may comprise a Bluetooth system and a WLAN system, including a duplicate of the Bluetooth system's frequency hop scheduler, in which the Bluetooth system may communicate, ahead of time, the combined times and frequencies of Bluetooth activity to a coexistence master residing in the WLAN system, and which may communicate an interference frequency band to the Bluetooth system in an exemplary embodiment of the present invention; and

FIG. 9 illustrates a flowchart for the coexistent multimode terminal according to FIG. 8, in which the coexistence master of the WLAN determines whether a Bluetooth transmssion/reception overlaps the frequency band of transmission of the WLAN system in an exemplary embodiment of the present invention; and

FIG. 10 illustrates a block diagram of a coexistent multimode terminal that may comprise a Bluetooth system and a WLAN system, in which the Bluetooth system may communicate, ahead of time, the combined times and frequencies of a future Bluetooth hop sequence to the WLAN system, and which may communicate an interference frequency band to the Bluetooth system in an exemplary embodiment of the present invention; and

FIG. 11 illustrates a flowchart for the coexistent multimode terminal according to FIG. 10, in which the WLAN determines whether a Bluetooth transmission/reception overlaps the frequency band of transmission of the WLAN system based on information communicated, ahead of time, from the Bluetooth system of the combined times and frequencies of a future Bluetooth hop sequence and, which may communicate an interference frequency band to the Bluetooth system in an exemplary embodiment of the present invention; and

FIG. 12A illustrates a coexistent multimode terminal including a single antenna connected to WLAN transceiver and a Bluetooth transceiver through a splitter/switch in an exemplary embodiment of the present invention; and

FIG. 12B illustrates a coexistent multimode terminal including a single antenna having a first portion that transmits/receives a horizontal component of a radio signal, which is connection to a WLAN transceiver, and a second portion that transmits/receives a vertical component of the radio signal, which is connected to a Bluetooth transceiver in an exemplary embodiment of present invention.

### DETAILED DESCRIPTION OF EXEMPLARY EMBODIMENTS

Generally, various exemplary embodiments of the present invention may provide a coexistent multimode terminal and a method of coexistence, in which wireless local area network (WLAN) transmissions/receptions are not impacted when there is no Bluetooth traffic, in which Bluetooth transmissions/receptions are not impacted when there is no WLAN traffic, in which Bluetooth and WLAN traffic, when both are present, are provided fair access to the medium, and in which high priority Bluetooth traffic, for example, voice traffic, has priority over non-high priority WLAN traffic.

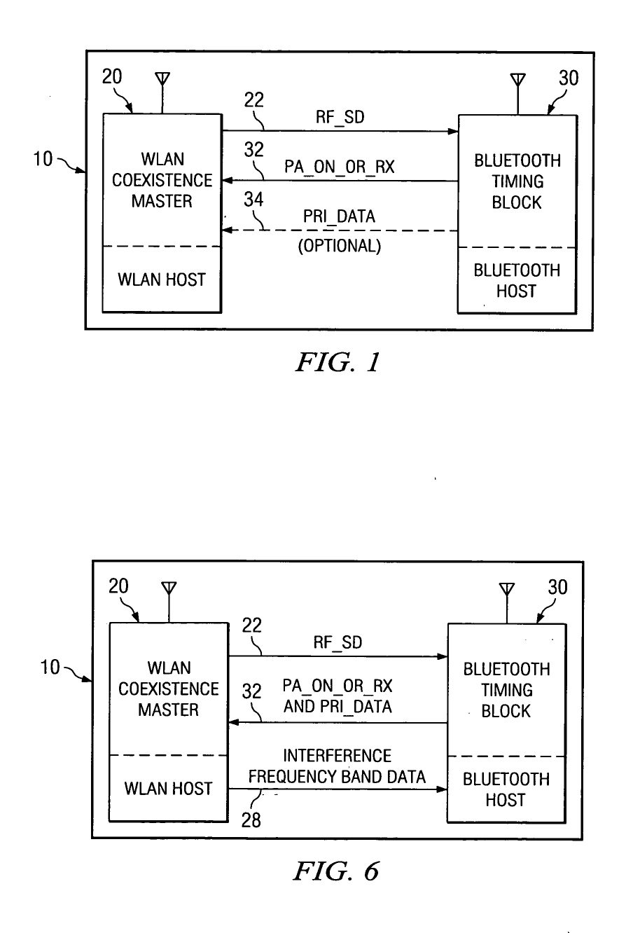

FIG. 1 illustrates a multimode terminal 10 in which a software-based coexistence master of a WLAN system 20, for example, Texas Instrument's TNETW1100b and TNETW1130 WLAN processors, may collaboratively determine those time periods when a Bluetooth system 30, for example, a Texas Instrument's BRF6100 single chip Bluetooth system, is active. In various exemplary embodiments, the WLAN system 20 may comprise an embedded system including the coexistence master or the coexistence master may interface with a WLAN host. The coexistence master may have knowledge of the internal state of the WLAN system 20 and knowledge of the Bluetooth system's 30 activity via a single input signal line or optionally two input signal lines in various exemplary embodiments of the present invention. The WLAN coexistence master may also disable or enable the radio of the Bluetooth system 30 via a single output signal line.

The Bluetooth system 30 may comprise an embedded system, in which various timing signals may be output, or a timing block that outputs the various timing signals and interfaces with a Bluetooth host in various exemplary embodiments of the present invention.

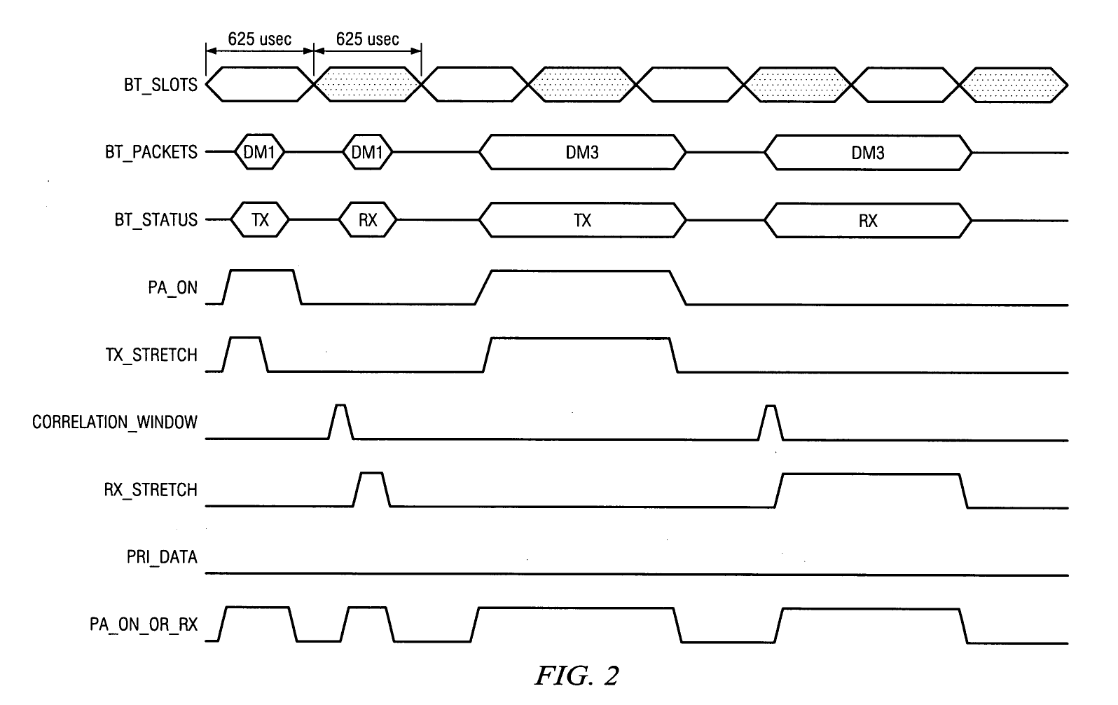

FIG. 2 illustrates a timing diagram for a master device of a Bluetooth system that may provide various timing signals for data communications, which are not designated high priority, in a coexistent multimode terminal of an exemplary embodiment of the present invention. For example, the timing signals TX_Stretch 10 and RX_Stretch 20 indicate, respectively, when the Bluetooth system is transmitting or receiving data packets. In various exemplary embodiments of the invention, PA_ON_OR_RX 40 may further include a power amplifier-on period, PA_ON 30, corresponding to a warm-up period for the Bluetooth's power amplifier (PA) when the Bluetooth system is about to transmit and power-on during the transmission. In various exemplary embodiments of the present invention, logical OR gates or a wired OR-function between the timing signals for PA_ON, TX_Stretch, and RX_Stretch may provide the timing signal, PA_ON_OR_RX.

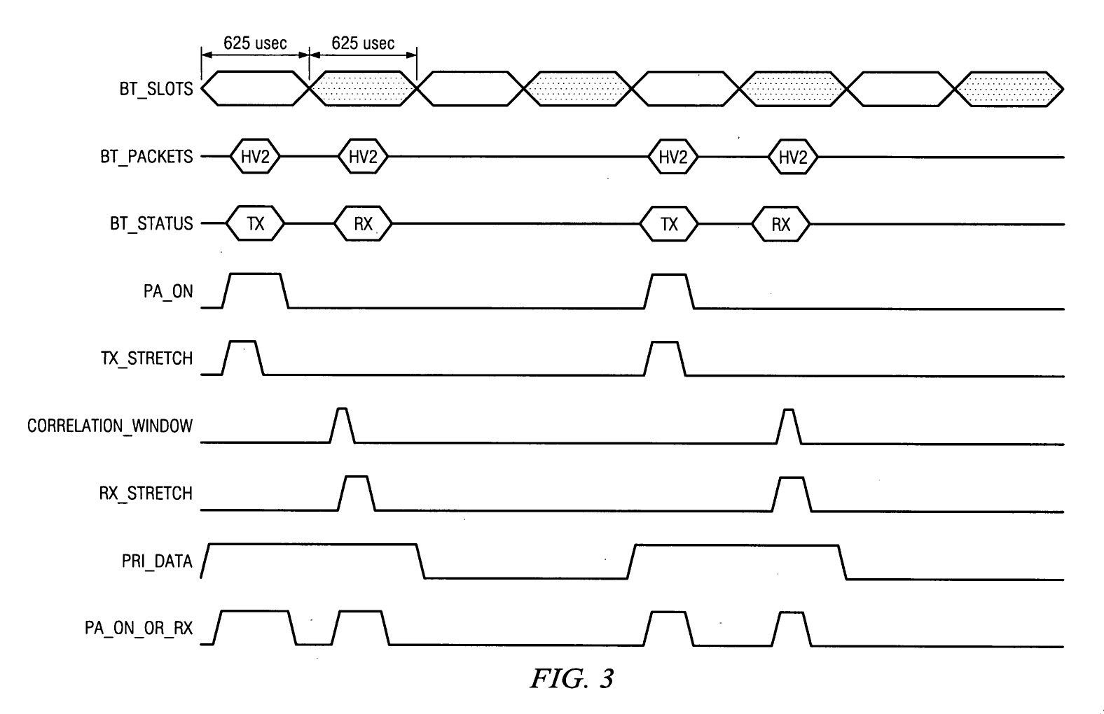

FIG. 3 illustrates a timing diagram for the master device of the Bluetooth system 30 that may provide an optional timing signal, PRI_DATA 10, for data communications, which are designated high priority in a coexistent multimode terminal of an exemplary embodiment of the present invention. For example, high priority data communications may include, e.g., SCO or eSCO linkages that may be used for voice communication. PRI_DATA 10 may be used to reserve access to the wireless medium for a period equal to at least a pair of time slots for the corresponding transmission/reception between the Bluetooth master of the multimode terminal and the slave device. PRI_DATA 10 may precede onset of the PA_ON_OR_RX 20 signal and extend beyond the end of the receiving timing signals to assure access priority to the wireless medium of high priority data and to assure that no spurious RF noise is introduced by the Bluetooth system from turning the power amplifier on or off during periods of Bluetooth reception or transmission.

Returning to FIG. 1, the WLAN system 20 may assert an RF Shutdown signal, RF_SD, that disables a power amplifier of the radio transceiver in the Bluetooth system 30 through a single output signal line 22. The output power of the Bluetooth power amplifier may be below −80 dBm, when shut down. When the WLAN system 20 does not assert RF_SD, the state of the power amplifier may be controlled by internal logic of the Bluetooth system 30. The RF_SD signal may be, for example, immediately asserted to turn the Bluetooth power amplifier off or immediately deasserted to turn the Bluetooth power amplifier on. In various exemplary embodiments of the present invention, there may be no soft shutdown or gradual power-on to prevent switching noise from emanating from the Bluetooth power amplifier. If the RF_SD signal were deasserted while the Bluetooth system 30 were attempting to transmit, i.e., while TX_Stretch 12 of FIG. 2 is valid, the RF_SD signal could cause spurious transients on the power amplifier output, as is well known in the art.

In various exemplary embodiments, the WLAN system 20 of FIG. 1 may receive the timing signal, PA_ON_OR_RX, which indicates that a Bluetooth transmission or reception is occurring or about to occur, via a single input signal line 32. The WLAN system 20 may also receive the timing signal, PRI_DATA, from the Bluetooth system 30 via an optional second input signal line 34 indicating that a high priority data transaction is about to occur or is occurring. Such a high priority link may indicate, for example, an SCO link, an eSCO link, or another type of high priority data.

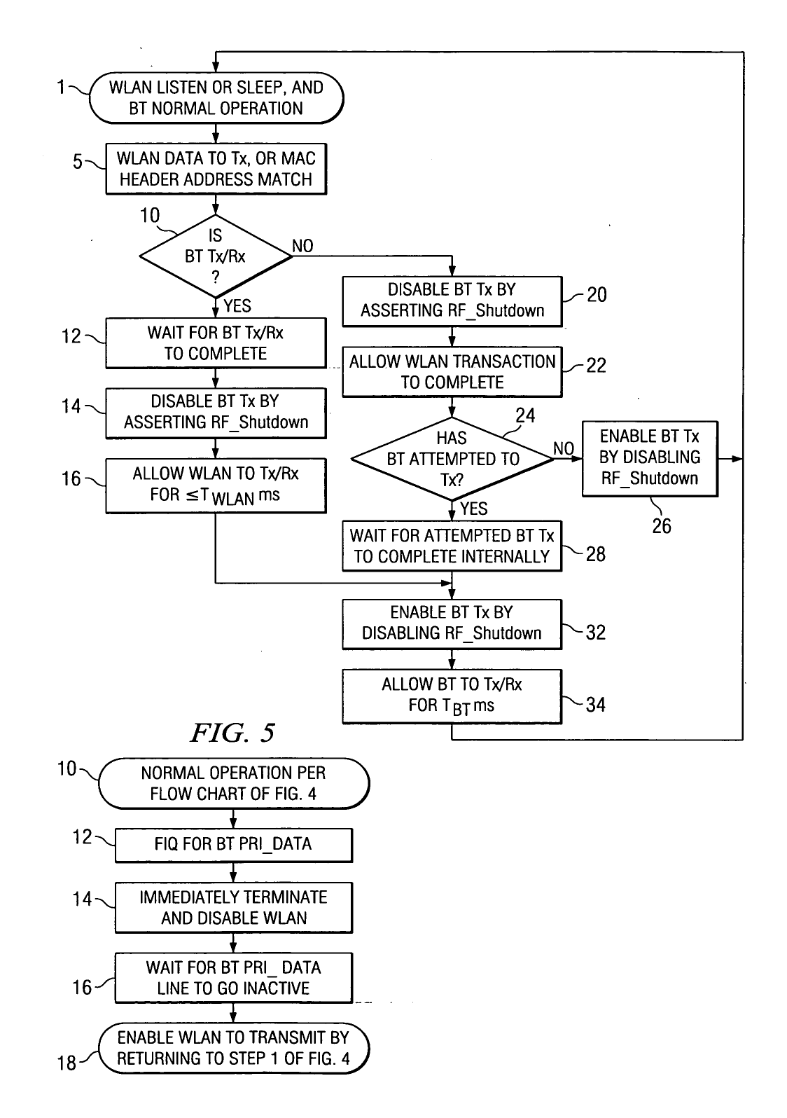

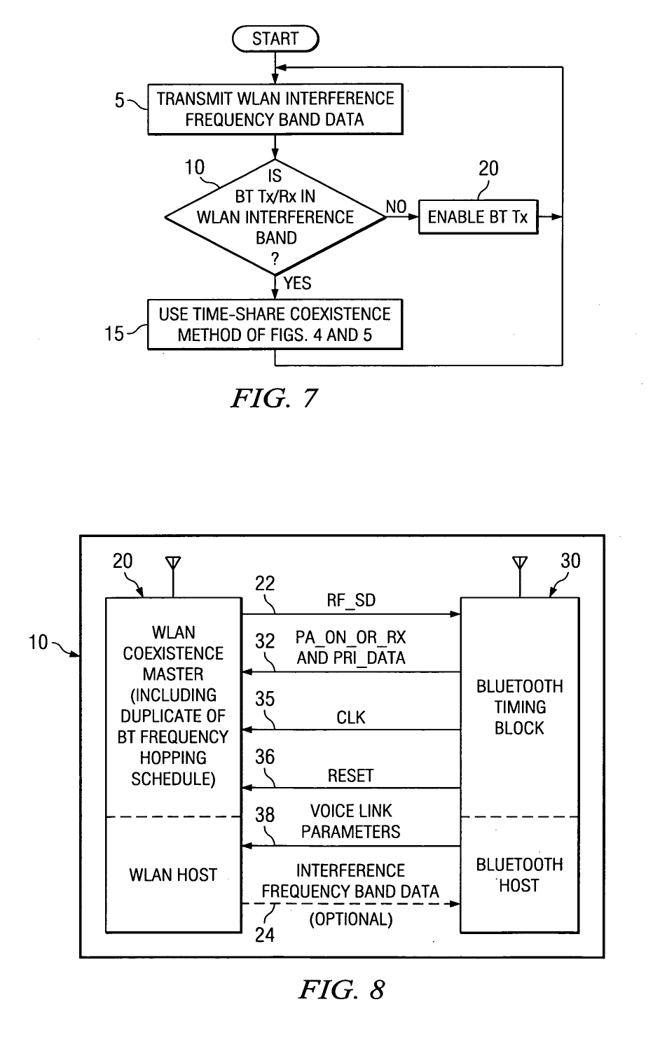

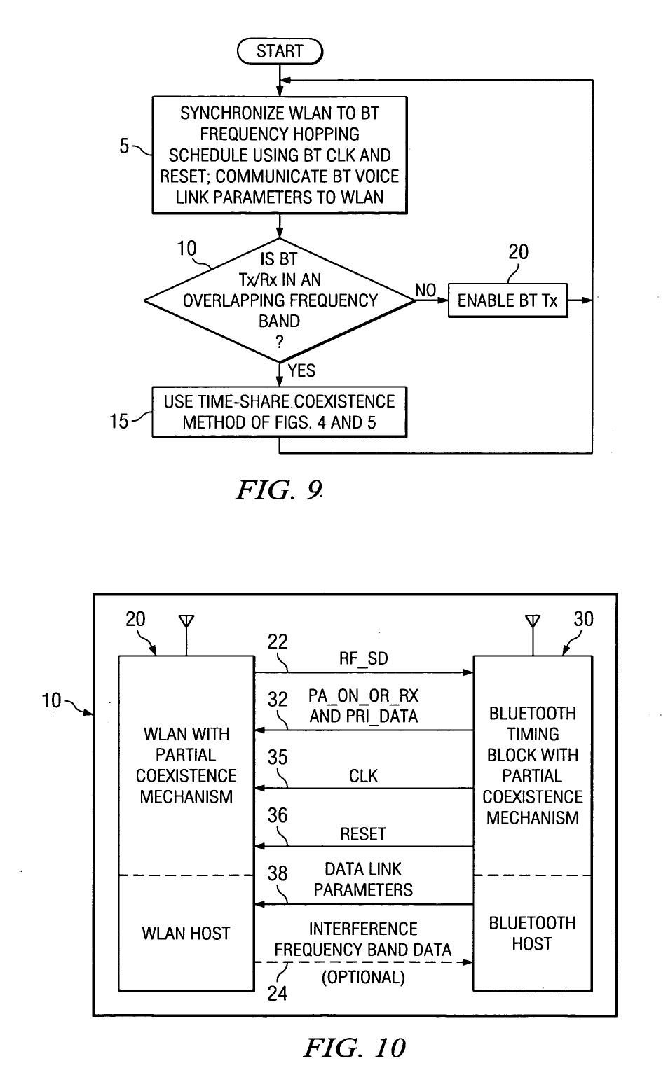

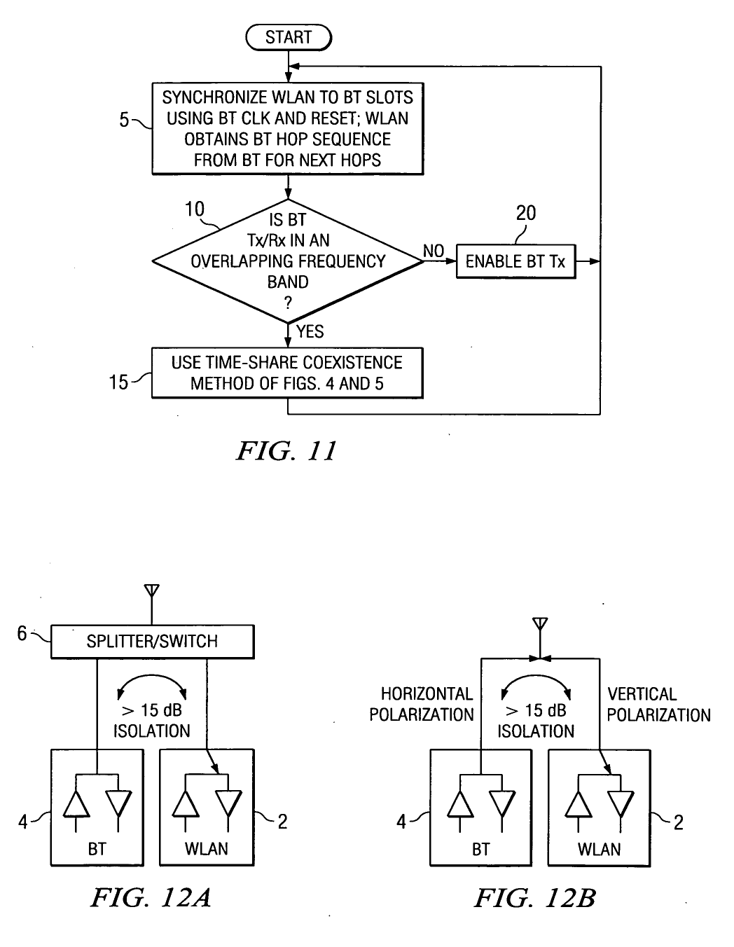

FIG. 4 illustrates a flow chart that depicts how the coexistence master of the WLAN system may collaboratively control Bluetooth communications that are not designated high priority. In its initial state 1, the WLAN system may be in a listen or sleep mode and the Bluetooth system may operate normally. Upon either hearing a WLAN Media Access Control (MAC) frame in which the WLAN system's address is matched or upon receiving an interrupt that indicates WLAN data is to be transmitted in 5, the WLAN coexistence master may then determine, whether the Bluetooth system is transmitting or receiving in 10, by checking the timing signal, PA_ON_OR_RX from the Bluetooth system.

If the Bluetooth system is transmitting or receiving, i.e., PA_ON_OR_RX is asserted in 10, then the WLAN system may wait for the Bluetooth transmission/reception to be completed in 12, i.e., PA_ON_OR_RX is deasserted. After completion of the Bluetooth transmission/reception, the WLAN system may then disable any Bluetooth transmissions by asserting RF_Shutdown in 14. After asserting RF_Shutdown, the WLAN system may then allow a period less than or equal to T_{WLAN} for contention-free transmission or reception in 16. In various exemplary embodiments, T_{WLAN} may range from approximately 1 msec to approximately 50 msec.

If the Bluetooth system is not transmitting or receiving, i.e., PA_ON_OR_RX is not asserted in 10, then the WLAN system may disable any Bluetooth transmissions by asserting RF_Shutdown in 20. The WLAN system may then allow the transaction that was detected in 5, i.e., either the transmission of WLAN data or the receiving of information corresponding to a MAC header address match, to be completed in 22.

Upon completion of the allowed WLAN system transaction in 22, the WLAN system may then determine whether the Bluetooth system had attempted to transmit while the WLAN system transaction was being completed in 24, by checking for signal interrupts corresponding to, for example, the timing signal PA_ON_OR_RX. If the Bluetooth system has not attempted to transmit, then the Bluetooth system may be enabled to transmit by disabling RF_Shutdown in 26. In this case, the WLAN system transaction of 22 has been completed; thus, the WLAN system may enter a sleep or listen mode, while the Bluetooth system operates normally.

On the other hand, if the Bluetooth system had attempted to transmit during the WLAN system transaction in 22, the attempted Bluetooth transmission, which had been initiated during the RF_Shutdown, may be allowed to proceed via the internal logic of the Bluetooth system to completion in 28. In this case, the attempted Bluetooth network communication fails because of the concomitant RF_Shutdown by the WLAN coexistence master. Lacking a positively acknowledged response by the Bluetooth slave device to the attempted transmission by the Bluetooth master device, this communication failure may then be treated as an error and the information subsequently re-transmitted. After completing the logical operations associated with the attempted and failed Bluetooth transmission, transmission by the Bluetooth system may be enabled by the WLAN coexistence master by disabling RF_Shutdown in 32. The Bluetooth system may then follow its internal logic to re-transmit information associated with the failed communication and to transmit/receive additional Bluetooth information for a period equal to T_{BT} in 34. In various exemplary embodiments, T_{BT} may range from approximately 1.25 msec to approximately 50 msec. At this point, the Bluetooth communication is completed and the multimode terminal system may enter its initial state.

In various exemplary embodiments of the present invention, the structure and method, as shown in FIGS. 1 and 4, respectively, may allow a multimode terminal 10 including a single output line 22 from a WLAN system 20 to a Bluetooth system 30 and a single input line 32 from the Bluetooth system 30 to the WLAN system 20 to communicate data, which is not of a high priority, by providing: Bluetooth transmissions during which the power amplifier is not turned on or off; no impact on WLAN traffic, if the Bluetooth system is not active; no impact on Bluetooth traffic, if the WLAN system is not active; and a fair sharing of the wireless medium if both Bluetooth and WLAN systems are active. It should also be noted that the minimum required Twlan interval will depend on WLAN Tx/Rx rate used and that the minimum require Tbt time will be dependent on the packet type being used.

FIG. 5 illustrates a flowchart that may provide uninterrupted Bluetooth communications, which are designated high priority, when an optional high priority data signal, PRI_DATA of FIG. 3, is provided in various exemplary embodiments of the present invention. The PRI_DATA signal may be derived from, for example, an SCO or an eSCO enable signal of the Bluetooth system and mapped to a fast interrupt of the WLAN system as is known to those in the art. Initially, FIG. 5 illustrates that a coexistent multimode terminal may operate normally in 10, as shown in FIG. 4, for Bluetooth signals, which are not designated high priority. Upon assertion of the PRI_DATA timing signal by the Bluetooth system, however, a fast interrupt (FIQ) of the WLAN system may, for example, be implemented in 12. The fast interrupt may immediately terminate and disable the WLAN system communication in 14. The WLAN system may then wait for the PRI_DATA line to go inactive in 16. Upon inactivation of the PRI_DATA line, the WLAN system may then be enabled by returning to the initial state 1 of FIG. 4. In various exemplary embodiments of the present invention, any failed WLAN communications that occur because of the fast interrupt are handled as transmission errors by the WLAN system and may be re-transmitted.

There are three types of Bluetooth SCO voice links that may be regarded as data of a high priority: HV1 voice packets, which are transmitted/received every 1.25 ms; HV2 voice packets, which are transmitted/received every 2.5 ms with a 1.25 ms inactive period between transmission/reception; and HV3 voice packets, which are transmitted/received every 3.75 ms with a 2.5 ms inactive period between transmission/reception. In various exemplary embodiments of the present invention, a coexistent WLAN system may communicate during the inactive periods associated with the transmission/reception of either HV2 or HV3 voice packets and perhaps, during a period that lasts but approximately 250 μs between the transmission and reception of HVI voice packets.

In various exemplary embodiments, the structure and method, as shown in FIGS. 1 and 5, respectively, may allow a coexistent multimode terminal 10 including a single output line 22, i.e, RF_SD, and two input lines 32, 34, i.e., PA_ON_OR_RX and PRI_DATA, respectively, to a WLAN coexistence master from a Bluetooth system 30 to communicate Bluetooth data, which is of a high priority, by providing a mechanism whereby high priority Bluetooth traffic, for example, SCO and eSCO voice packets, takes priority over WLAN traffic.

In various exemplary embodiments of the present invention, logical OR gates or a wired OR-function between the timing signals for PA_ON, TX_Stretch and RX_Stretch, and the PRI_DATA signal may be input to the WLAN coexistence master over a single serial input line to communicate an active Bluetooth state.

FIG. 6 illustrates a multimode terminal 10 including a WLAN system 20 that implements a software-based coexistence method using a combined frequency range/time-sharing method. At or near start-up, the WLAN system 20 transmits to the Bluetooth system 30, a frequency range for which RF interference may occur during simultaneous Bluetooth and WLAN operation. This frequency range may, for example, start below the lower range of the known WLAN operating frequency and extend beyond the upper range of the WLAN operating frequency. In the U.S. and Canada, for example, a WLAN may use a direct-sequence spread spectrum (DSSS) modulation having a 5 MHz channel for signal transmission in which the two 5 MHz channels that are adjacent to and lower in frequency than the transmission channel and the two 5 MHz channels that are adjacent to and higher in frequency than the transmission channel, act as guard bands to radio interference from other DSSS transmitting channels. Thus, a WLAN using DSSS may have an operating frequency band of approximately 25 MHz, which includes a channel for signal transmission/reception and, lower and upper guard bands. In the U.S. and Canada, for example, Bluetooth frequency-hopping takes place over 1 MHz frequency bands from 2.402 to 2.479 GHz for allowed channels 2 to 79. Thus, there may be many 1 MHz bands located below and above a WLAN's signal operating frequency range and its associated guard bands where radio interference between a WLAN system and a Bluetooth system may not occur. Similarly, transmission channels and guard bands of a frequency range substantially less than that of the ISM 2.4 to 2.5 GHz RF band may be used for High Rate/DSSS modulation and Orthogonal Frequency Division Multiplexing (OFDM) of WLAN systems in various exemplary embodiments of the present invention.

Returning to FIG. 6, the WLAN host or an embedded system including the WLAN coexistence master may output the WLAN system's 20 operating frequency band and associated guard bands to the Bluetooth system 30 at or near start-up via a serial line 28 in various exemplary embodiments of the system. When signaling activity of the Bluetooth system 30 to the coexistence master of the WLAN system 20, the signal line 32 may, for example, provide the timing signals PA_ON_OR_RX and PRI_DATA via a single output line, or alternatively, two output lines, only when the 1 MHz Bluetooth operating frequency band for the to-be-active Bluetooth hop overlaps the known WLAN system's 20 operating frequency and associated guard bands.

FIG. 7 illustrates a flowchart for the combined frequency range/time-sharing coexistence method implemented by the multimode terminal of FIG. 6. After starting the coexistent multimode terminal, the WLAN system may, for example, transmit its operating frequency band, i.e., a frequency band that will cause interference with Bluetooth system transmissions, to the Bluetooth system in 5. In various exemplary embodiments of the present invention, the WLAN system may then determine whether the Bluetooth signal to be transmitted and received falls within the operating frequency of the WLAN system in 10. When a 1 MHz Bluetooth operating frequency band for a to-be-active Bluetooth hop does not overlap the WLAN system's operating frequency and associated guard bands, i.e., BT Tx/Rx does not overlap the WLAN interference band in 20, the Bluetooth system's transmissions may be enabled. Thus, both the Bluetooth system and the WLAN system may operate simultaneously without radio interference. When a 1 MHz Bluetooth operating frequency band for the to-be-active Bluetooth hop overlaps the WLAN system's operating frequency and associated guard bands, i.e., BT Tx/Rx does overlap the WLAN interference band in 20, the coexistence master falls back to the time-sharing coexistence method illustrated by FIGS. 4 and 5.

The combined frequency range/time-sharing coexistence system and method, illustrated in FIGS. 6 and 7, may allow a Bluetooth system that, for example, incorporates Bluetooth version 1.2 with adaptive frequency-hopping (AFH) to always operate in frequency bands where there is no overlap with the operating frequency of the WLAN. In various exemplary embodiments of the present invention, it may be anticipated that even a Bluetooth system version 1.1 will transmit simultaneously with the WLAN over half of the time in the non-interfering frequency bands. Hence, a significant enhancement of throughput over the time-sharing coexistence mechanism illustrated in FIGS. 4 and 5 is anticipated.

FIG. 8 illustrates a multimode terminal 10 in which a software-based coexistence master of a WLAN system 20 may, for example, be informed ahead of time of the frequencies to be used by Bluetooth versions 1.1 and 1.2 for future frequency hops. In various exemplary embodiments of the present invention, the coexistence master of the WLAN system 20 may include a duplicate of the frequency hop scheduler used by the Bluetooth system 30. The duplicate frequency hop scheduler of the WLAN system 20 may be synchronized to the frequency hop scheduler of the Bluetooth system 30 by clock 34 and reset 36 lines from the Bluetooth system 30 by means well known to those in the art. In various exemplary embodiments of the present invention, the Bluetooth system 30 may further communicate to the coexistence master of the WLAN system 20, parameters of high priority data, for example, the slot boundary for the scheduled onset of the 1.25 ms inactive period between transmission and reception of HV2 voice packets. The transmission of such parameters of high priority data from the Bluetooth system 30 to the coexistence master of the WLAN system 20 may occur via a serial line 38 linking the Bluetooth host with the WLAN host when the high priority data link is established.

Referring to FIG. 8, the coexistence master of the WLAN system 20 may determine, ahead of time, by operation of the duplicate frequency hop scheduler and its synchronization to the Bluetooth system 30, the frequencies to be used by Bluetooth system 30 for future pairs of time slots. The Bluetooth system 20 may also provide the timing signals PA_ON_OR_RX and PRI_DATA, which indicate Bluetooth activity, by a single output line 32, or alternatively, by two output lines, only when the Bluetooth operating frequency band for the to-be-active Bluetooth hop overlaps the known WLAN system's 20 operating frequency. The coexistence master of the WLAN system 20 may then determine whether it is to transmit/receive in its operating frequency band at future periods based on received knowledge of the Bluetooth system's 30 scheduled future activity and its corresponding scheduled future frequency bands of operation. Optionally, the WLAN system 20 may also transmit to the Bluetooth system 30, at or near start-up, a frequency range for which RF interference may occur during simultaneous Bluetooth and WLAN operation to reduce a number of Bluetooth processor operations. Simultaneous operation of Bluetooth and WLAN systems 20, 30 is possible for non-overlapping frequency bands. When Bluetooth and WLAN systems 20, 30 overlap in operating frequencies, e.g., which may occur with Bluetooth version 1.1, the coexistence master of the WLAN system 20 may fall back to the time-sharing coexistence method illustrated by FIGS. 4 and 5.

FIG. 9 illustrates a flowchart for the look-ahead and combined frequency range/time-sharing coexistence method implemented by the coexistent multimode terminal of FIG. 8. After starting the coexistent multimode terminal, the Bluetooth system transmits clock and reset signals to the WLAN coexistence master to permit synchronization of the duplicate Bluetooth frequency hop scheduler residing in the WLAN with that of the Bluetooth system and high-priority data parameters to provide look-ahead for deterministic Bluetooth operating sequences in 5. In various exemplary embodiments of the present invention, the WLAN system may then determine whether the Bluetooth signal to be transmitted and received falls within the operating frequency of the WLAN system in 10. When a Bluetooth operating frequency band for a to-be-active Bluetooth transmission/reception does not overlap the WLAN system's operating frequency, i.e., BT Tx/Rx does not overlap the WLAN interference band, the Bluetooth system's transmissions may be enabled in 20. Thus, both the Bluetooth system and the WLAN system may operate simultaneously without radio interference. When the Bluetooth operating frequency band for the to-be-active Bluetooth transmission/reception overlaps the WLAN system's operating frequency, i.e., BT Tx/Rx does overlap the WLAN interference band, the coexistence master falls back to the time-sharing coexistence method illustrated by FIGS. 4 and 5 in 15.

The look-ahead and combined frequency range/time-sharing coexistence system and method, illustrated in FIGS. 8 and 9, may allow WLAN operation to be determined in advance, based on future knowledge of the Bluetooth system's activity, e.g., voice links are deterministic in time, whereas fallback to the combined frequency range/time-sharing coexistence method illustrated in FIGS. 6 and 7 only occurs when a non-deterministic Bluetooth event occurs, e.g., a retransmission in a voice link operating under Bluetooth version 1.2, and fallback to the time-sharing coexistence method illustrated by FIGS. 4 and 5 occurs only when the Bluetooth and WLAN operating frequency bands overlap.

FIG. 10 illustrates a multimode terminal 10 in which a look-ahead and combined frequency range/time-sharing coexistence method is shared between WLAN system 20 and the Bluetooth system 30. Rather than duplicating the frequency hop scheduler used by the Bluetooth system 30 in a WLAN coexistence master, as in FIG. 8, the WLAN of an exemplary embodiment of the present system may receive future hop sequence information from the Bluetooth system 30 for a limited sequence of future hops, for example, approximately 15 future hops. Thus, the future hop sequence information may be intermittently transmitted ahead of time to the WLAN system 20 and may be based on a deterministic sequence known by the Bluetooth system 30. In various exemplary embodiments of the present invention, the WLAN system 20 may be synchronized to the time slots of the frequency hop sequence of the Bluetooth system 30 by clock 34 and reset 36 lines from the Bluetooth system 30 by means well known to those in the art. In various exemplary embodiments of the present invention, the Bluetooth system 30 may further communicate to the partial coexistence mechanism of the WLAN system 20, parameters of high priority data, for example, the slot boundary times for voice packets. The transmission of such parameters of high priority data from the Bluetooth system 30 to the coexistence mechanism of the WLAN system 20 may occur via a serial line 38 for data link parameters between the Bluetooth system with the WLAN system.

Referring to FIG. 10, the coexistence mechanism of the WLAN system 20 may determine, ahead of time, by future frequency hop information received from the Bluetooth system 30, the frequencies to be used by Bluetooth system 30 for future pairs of time slots. The Bluetooth system 20 may also provide the timing signals PA_ON_OR_RX and PRI_DATA, which indicate Bluetooth activity, by a single output line 32, or alternatively, by two output lines, only when the Bluetooth operating frequency band for the to-be-active Bluetooth hop overlaps the known WLAN system's 20 operating frequency. The coexistence mechanism of the WLAN system 20 may then determine whether it is to transmit/receive in its operating frequency band at future periods based on received knowledge of the Bluetooth system's 30 scheduled future activity and its corresponding scheduled future frequency bands of operation. Optionally, the WLAN system 20 may also transmit to the Bluetooth system 30, at or near start-up, a frequency range for which RF interference may occur during simultaneous Bluetooth and WLAN operation to reduce a number of Bluetooth processor operations.

FIG. 11 illustrates a flowchart for the look-ahead and combined frequency range/time-sharing coexistence method implemented by the coexistent multimode terminal of FIG. 10. After starting the coexistent multimode terminal, the WLAN coexistence mechanism may be synchronized to the boundaries of the Bluetooth system's time slots by use of the clock and reset lines as is well known to those in the art and the WLAN may obtain information about the future Bluetooth hop sequence for the next number of future hops in 5. In various exemplary embodiments of the present invention, the WLAN system may then determine whether the Bluetooth signal to be transmitted and received falls within the operating frequency of the WLAN system in 10. When a Bluetooth operating frequency band for a to-be-active Bluetooth transmission/reception does not overlap the WLAN system's operating frequency, i.e., BT Tx/Rx does not overlap the WLAN interference band, the Bluetooth system's transmissions may be enabled in 20. Thus, both the Bluetooth system and the WLAN system may operate simultaneously without radio interference. When the Bluetooth operating frequency band for the to-be-active Bluetooth transmission/reception overlaps the WLAN system's operating frequency, i.e., BT Tx/Rx does overlap the WLAN interference band, the coexistence master falls back to the time-sharing coexistence method illustrated by FIGS. 4 and 5 in 15.

Although the coexistent multimode terminals illustrated in FIGS. 1, 6, 8, and 10 depict separate antennae for the WLAN system 20 and the Bluetooth system 30, it is within the scope of an exemplary embodiment of the present invention, to implement the coexistent multimode terminal of these exemplary embodiments with a single antenna. FIG. 12 A illustrates a WLAN system's transceiver 2 and a Bluetooth system's transceiver 4 that may be connected by a splitter/switch 6 that would be controlled by the coexistence master or the coexistence mechanism of the exemplary embodiments of the present invention described above. The splitter/switch may require, for example, electrical isolation of greater than 15 dB between the inputs from the WLAN system's transceiver 2 and the Bluetooth system's transceiver 4. Alternatively, as illustrated in FIG. 12B, a WLAN system's transceiver 2 may be connected to a first portion of a single antenna structure, which transmits vertically polarized RF signals, while a Bluetooth system's transceiver 4 may be connected to a second portion of a single antenna structure, which transmits vertically polarized RF signals, in various exemplary embodiments of the present invention. Electrical isolation of greater than 15 dB between the inputs from the WLAN system's transceiver 2 and the Bluetooth system's transceiver 4 may be required between the first and second portions of the single antenna structure, which transmit vertically polarized and horizontally polarized RF signals, respectively.

Because many varying and different exemplary embodiments may be made within the scope of the inventive concepts taught herein, and because many modifications may be made in the exemplary embodiments detailed herein in accordance with the descriptive requirements of the law, it is to be understood that the detailed descriptions herein are to be interpreted as illustrative and not in a limiting sense.

What is claimed:

1. A coexistent multimode terminal, comprising:
a wireless local area network (WLAN) system including a coexistence master;
a Bluetooth system;
a Bluetooth radio shut-down signal output from the coexistence master to the Bluetooth system;
a first timing signal output from the Bluetooth system to the coexistence master, the first timing signal indicating transmission/reception by the Bluetooth system; and
a first algorithm residing in the coexistence master, such that when WLAN data is available for transmission or the WLAN system recognizes an address match, the first algorithm causes the coexistence master to output the Bluetooth radio shut-down signal after the first timing signal from the Bluetooth system is deasserted.

2. The coexistent multimode terminal of claim 1, further comprising:
a second timing signal output from the Bluetooth system to the coexistence master, the second timing signal indicating that transmission/reception of high priority data, including voice data, is about to occur from the Bluetooth system; and
a second algorithm logically linked to the first algorithm, such that upon receiving the second timing signal, the second algorithm causes a WLAN transmission/reception to be terminated and the Bluetooth radio shut-down signal to be deasserted.

3. A method of coexistence for a multimode terminal, comprising:
determining by a coexistent WLAN system, whether WLAN data is to be transmitted or the coexistent WLAN system recognizes an address match;
determining whether a Bluetooth system is transmitting/receiving by accessing a first timing signal from the Bluetooth system to the coexistent WLAN system;
if the Bluetooth system is transmitting/receiving, then allowing a Bluetooth transmission/reception to complete, before disabling Bluetooth transmission by asserting a Bluetooth radio shut-down signal from the coexistent WLAN system; and
if the Bluetooth system is not transmitting/receiving, then disabling the Bluetooth transmission.

4. The method of coexistence for a multimode terminal of claim 3, further comprising:
after the Bluetooth transmission/reception is completed and the Bluetooth transmission is disabled, allowing the coexistent WLAN system to transmit/receive for up to T_{WLAN} ms; and
after the transmission/reception for up to T_{WLAN} ms is completed, enabling the Bluetooth transmission/reception for T_{BT} ms by deasserting the Bluetooth radio shut-down signal from the coexistent WLAN system.

5. The method of coexistence for a multimode terminal of claim 3, further comprising:
after determining WLAN data is to be transmitted or the coexistent WLAN system recognizes an address match, and the Bluetooth transmission is disabled, then allowing the WLAN data to be transmitted or the address match to proceed to reception.

6. The method of coexistence for a multimode terminal of claim 5, further comprising:
after allowing the WLAN data to be transmitted or the address match to proceed to reception, then determining whether a Bluetooth transmission was attempted during the WLAN data transmission or reception.

7. The method of coexistence for a multimode terminal of claim 6, further comprising:
if the Bluetooth transmission was attempted during the WLAN data transmission or reception, then waiting for the Bluetooth transmission to internally complete within the Bluetooth system; and
subsequently enabling Bluetooth transmission.

8. The method of coexistence for a multimode terminal of claim 6, further comprising:
if the Bluetooth transmission was not attempted during the WLAN data transmission or reception, then enabling Bluetooth transmission.

9. The method of coexistence for a multimode terminal of claim 3, further comprising:
asserting a high priority data timing signal from the Bluetooth system to the coexistent WLAN system, the high priority data timing signal indicating that transmission/reception of high priority data, including voice data, is about to occur from the Bluetooth system; and
then terminating and disabling a coexistent WLAN transmission/reception.

10. A coexistent multimode terminal, comprising:
a wireless local area network (WLAN) system including a coexistence master;
a Bluetooth system;
a Bluetooth radio shut-down signal output from the coexistence master to the Bluetooth system;
data, including an interference frequency band, that is output from the WLAN system to the Bluetooth system;
a first timing signal output from the Bluetooth system to the coexistence master, the first timing signal indicating transmission/reception by the Bluetooth system, wherein
the first timing signal is output only when a frequency of transmission for the Bluetooth system falls within the interference frequency band; and
a first algorithm residing in the coexistence master, such that when WLAN data is available for transmission or the WLAN system recognizes an address match, the first algorithm causes the coexistence master to output the Bluetooth radio shut-down signal after the first timing signal from the Bluetooth system is deasserted.

11. The coexistent multimode terminal of claim 10 further comprising:
a second timing signal output from the Bluetooth system to the coexistence master, the second timing signal indicating that transmission/reception of high priority data, including voice data, is about to occur from the Bluetooth system; and
a second algorithm logically linked to the first algorithm, such that upon receiving the second timing signal, the second algorithm causes a WLAN transmission/reception to be terminated and the Bluetooth radio shut-down signal to be deasserted.

12. A method of coexistence for a multimode terminal, comprising:
outputting from a coexistent WLAN system to a Bluetooth system, data including an interference frequency band;
determining by the coexistent WLAN system, whether WLAN data is to be transmitted or the coexistent WLAN system recognizes an address match;
determining whether a Bluetooth system is transmitting/receiving in the interference frequency band by accessing a first timing signal from the Bluetooth system to the coexistent WLAN system, wherein
the first timing signal is output from the Bluetooth system only when a frequency of transmission of the Bluetooth system falls within the interference frequency band;
if the Bluetooth system is transmitting/receiving in the interference frequency band, then allowing a Bluetooth transmission/reception to complete, before disabling Bluetooth transmission by asserting a Bluetooth radio shut-down signal from the coexistent WLAN system; and
if the Bluetooth system is not transmitting/receiving in the interference frequency band, then disabling the Bluetooth transmission.

13. The method of coexistence for a multimode terminal of claim 12, further comprising:
asserting a high priority data timing signal from the Bluetooth system to the coexistent WLAN system, the high priority data timing signal indicating that transmission/reception of high priority data, including voice data, is about to occur in the interference frequency band from the Bluetooth system; and
then terminating and disabling a coexistent WLAN transmission/reception.

14. A coexistent multimode terminal, comprising:
a wireless local area network (WLAN) system;
a Bluetooth system, wherein
the WLAN system includes a coexistence master that includes information of a transmission/reception frequency of the WLAN system and a duplicate of the Bluetooth system's frequency hopping scheduler;
a Bluetooth radio shut-down signal output from the coexistence master to the Bluetooth system;
a first timing signal output from the Bluetooth system to the coexistence master, the first timing signal indicating transmission/reception by the Bluetooth system, wherein
the first timing signal is output only when a frequency of transmission for the Bluetooth system interferes with the transmission/reception frequency of the WLAN system;
a clock signal and a reset signal output from the Bluetooth system to the coexistence master for synchronizing the coexistence master's duplicate of the Bluetooth system's frequency hopping scheduler with the Bluetooth frequency hopping scheduler;
voice link parameter information that is transmitted ahead of time to the coexistence master; and
a first algorithm residing in the coexistence master, such that when WLAN data is available for transmission or the WLAN system recognizes an address match, the first algorithm causes the coexistence master to output the Bluetooth radio shut-down signal after the first timing signal from the Bluetooth system is deasserted.

15. The coexistent multimode terminal of claim 14, further comprising:
a serial output line from the WLAN system to the Bluetooth system that outputs interference frequency band data.

16. The coexistent multimode terminal of claim 14, further comprising:
a second timing signal output from the Bluetooth system to the coexistence master, the second timing signal indicating that transmission/reception of high priority data, corresponding to the voice link parameter information, is about to occur from the Bluetooth system; and
a second algorithm logically linked to the first algorithm, such that upon receiving the second timing signal, the second algorithm causes a WLAN transmission/reception to be terminated and the Bluetooth radio shut-down signal to be deasserted.

17. A method of coexistence for a multimode terminal, comprising:
synchronizing a duplicate of a Bluetooth system's frequency hopping scheduler, residing in a coexistence master of a WLAN system, with the Bluetooth system's frequency hopping scheduler by clock and reset signal from the Bluetooth system;
communicating, ahead of time, Bluetooth voice link parameter information to the coexistence master;
determining by the coexistent WLAN system, whether WLAN data is to be transmitted or the WLAN system recognizes an address match;
determining by the coexistent WLAN system, whether the Bluetooth system is transmitting/receiving in a frequency band, which overlaps a transmission frequency band of the coexistent WLAN system, by accessing a first timing signal from the Bluetooth system to the coexistent WLAN system, wherein
the first timing signal is output from the Bluetooth system only when the frequency band of transmission/reception of the Bluetooth system overlaps the transmission frequency band of the coexistent WLAN system;
if the Bluetooth system is transmitting/receiving in the transmission frequency band of the coexistent WLAN system, then allowing a Bluetooth transmission/reception to complete, before disabling Bluetooth transmission by asserting a Bluetooth radio shut-down signal from the coexistent WLAN system; and
if the Bluetooth system is not transmitting/receiving in the transmission frequency band of the coexistent WLAN system, then disabling the Bluetooth transmission.

18. The method of coexistence for a multimode terminal of claim 16, further comprising:
outputting interference frequency band data from the coexistent WLAN system to the Bluetooth system.

19. The method of coexistence for a multimode terminal of claim 16, further comprising:
asserting a high priority data timing signal from the Bluetooth system to the coexistent WLAN system, the high priority data timing signal indicating that transmission/reception of high priority data, corresponding to the voice link parameter information, is about to occur in the interference frequency band from the Bluetooth system; and
then terminating and disabling a coexistent WLAN transmission/reception.

20. A coexistent multimode terminal, comprising:
a wireless local area network (WLAN) system;
a Bluetooth system;
a Bluetooth radio shut-down signal output from the Bluetooth system;
a first timing signal output from the Bluetooth system to the WLAN system, the first timing signal indicating transmission/reception by the Bluetooth system, wherein
the first timing signal is output only when a frequency of transmission for the Bluetooth system interferes with the transmission/reception frequency of the WLAN system;
a clock signal and a reset signal output from the Bluetooth system to the WLAN system for synchronizing the WLAN system to Bluetooth slot boundaries;
data link parameter information, including a future hop sequence, that is transmitted ahead of time from the Bluetooth system to the WLAN system; and
a first algorithm residing in the WLAN system, such that when WLAN data is available for transmission or the WLAN system recognizes an address match, the first algorithm causes the WLAN system to output the Bluetooth radio shut-down signal after the first timing signal from the Bluetooth system is deasserted.

21. The coexistent multimode terminal of claim 20, further comprising:
a serial output line from the WLAN system to the Bluetooth system that outputs interference frequency band data.

22. The coexistent multimode terminal of claim 20, further comprising:
a second timing signal output from the Bluetooth system to the WLAN, the second timing signal indicating that transmission/reception of high priority data, corresponding to the data link parameter information, is about to occur from the Bluetooth system; and
a second algorithm logically linked to the first algorithm, such that upon receiving the second timing signal, the second algorithm causes a WLAN transmission/reception to be terminated and the Bluetooth radio shut-down signal to be deasserted.

23. A method of coexistence for a multimode terminal, comprising:
synchronizing a WLAN system to slot boundaries of a Bluetooth system by clock and reset signals from the Bluetooth system;
communicating, ahead of time, data voice link parameter information, including a future hop sequence, from the Bluetooth system to the WLAN system;
determining by the WLAN system, whether WLAN data is to be transmitted or the WLAN system recognizes an address match;
determining by the WLAN system, whether the Bluetooth system is transmitting/receiving in a frequency band, which overlaps a transmission frequency band of the WLAN system, by accessing a first timing signal from the Bluetooth system to the WLAN system, wherein
the first timing signal is output from the Bluetooth system only when the frequency band of transmission/reception of the Bluetooth system overlaps the transmission frequency band of the WLAN system;
if the Bluetooth system is transmitting/receiving in the transmission frequency band of the WLAN system, then allowing a Bluetooth transmission/reception to complete, before disabling Bluetooth transmission by asserting a Bluetooth radio shut-down signal from the WLAN system; and
if the Bluetooth system is not transmitting/receiving in the transmission frequency band of the WLAN system, then disabling the Bluetooth transmission.

24. The method of coexistence for a multimode terminal of claim 23, further comprising:
outputting interference frequency band data from the WLAN system to the Bluetooth system.

25. The method of coexistence for a multimode terminal of claim 23, further comprising:
asserting a high priority data timing signal from the Bluetooth system to the WLAN system, the high priority data timing signal indicating that transmission/reception of high priority data, corresponding to the data link parameter information, is about to occur in the interference frequency band from the Bluetooth system; and
then terminating and disabling a WLAN transmission/reception.

26. The coexistent multimode terminal of claim 1, further comprising:
a single antenna connected to a splitter/switch connected to a WLAN system's transceiver and a Bluetooth system's transceiver, wherein
the WLAN system's transceiver and the Bluetooth system's transceiver are electrically isolated from one another by the splitter/switch by more than 15 dB.

27. The coexistent multimode terminal of claim 1, further comprising:
a single antenna including a first portion that transmits/receives a vertically polarized component of a radio signal and a second portion that transmits/receives a horizontally polarized component of the radio signal, wherein
a WLAN system's transceiver is connected to the second portion and a Bluetooth system's transceiver is connected to the first portion of the single antenna, and
the WLAN system's transceiver and the Bluetooth system's transceiver are electrically isolated from one another by the first portion and the second portion of the single antenna by more than 15 dB.
